(19) United States
(12) Patent Application Publication
(10) Pub. No.: US 2023/0107191 A1
(43) Pub. Date: Apr. 6, 2023

(54) DATA OBFUSCATION PLATFORM FOR IMPROVING DATA SECURITY OF PREPROCESSING ANALYSIS BY THIRD PARTIES

(71) Applicant: Matthew Wong, Medina, WA (US)

(72) Inventor: Matthew Wong, Medina, WA (US)

(21) Appl. No.: 17/494,811

(22) Filed: Oct. 5, 2021

(51) Int. Cl. G06F 21/60

(52) U.S. Cl. CPC G06F 21/60; G06F 2221/2115

(57) ABSTRACT

A system is disclosed for providing a data obfuscation platform useful for improved data security of preprocessing analysis of the data by a third party server. The system comprises: (a) a data store for storing: (1) sets of pre-processing analysis data created by a plurality of applications of different formats and/or organized by different standards; (2) a plurality of categories for the pre-processing the data and a plurality of rules for obfuscating the pre-processing data based on the categories; and (3) a data obfuscation engine for obfuscating the pre-processing analysis data; (b) one or more servers coupled to the data store and programmed to obfuscate the data by the data obfuscation engine before data preprocessing analysis by the third party server.

### CROSS REFERENCE TO RELATED APPLICATIONS

Not applicable.

### FIELD OF THE INVENTION

The present invention relates to a data obfuscation platform for improving data security of preprocessing analysis by third parties.

### BACKGROUND OF THE INVENTION

Today, large volumes of data are aggregated in the process of executing various business functions. The data may be in tabular or other data form, but much of this data (regardless of type) are created by numerous applications/sources such as spreadsheets, webpages, and databases. In many instances, the data can only be used after it has been preprocessed (e.g., “recognized,” “normalized,” “standardized,” “cleaned” and/or otherwise transformed), and analysis of the data is required to determine what the requisite preprocessing steps will be. This determination or “preprocessing analysis” may assist when using other software applications. Unfortunately, such data may be of a sensitive nature and some of the software data analysis applications could be owned and/or operated by a third party, which may or may not be “trusted” by the party possessing the data. Thus, using such applications to analyze the data may raise security, privacy, regulatory and/or other concerns. This creates a challenge to preprocessing the data into a usable form. Today, although various applications and methods exist for masking, obfuscating and encrypting data, or otherwise to improve the security of using untrusted applications on sensitive data, such approaches are generally designed to operate on data that has already been preprocessed, and such approaches are generally limited, impractical or unusable for the purpose of preprocessing analysis.

### SUMMARY OF THE INVENTION

A system and method are disclosed for providing a data obfuscation platform for improved data security of preprocessing analysis by third parties.

In accordance with an embodiment of the present disclosure, a system is disclosed for providing a data obfuscation platform useful for improved data security of preprocessing analysis by a third party server, the data to be analyzed being tabular data created by a plurality of applications and stored in different formats and/or organized by different standards recognizing tabular data created by a plurality of applications and stored in different formats and/or organized by different standards, the system comprising: (a) a data store for storing (1) sets of unrecognizable tabular data created by a plurality of applications of different formats and/or organized by different standards, each set of tabular data having cells of data within one or more input columns and (2) a plurality of categories for the data within the cells and a plurality of rules for obfuscating the data within the cells based on the categories; and (b) one or more servers coupled to the data store and programmed to: (1) identifying the column names of the input columns; (2) for data in each cell of the one or more input columns, trimming leading and trailing white space; (3) determining whether a data in each cell matches a value of designated set of pair of Boolean values where each pair corresponds to a distinctly formatted se of true and false values; (4) if a match is determined, randomly selecting to retain current value or corresponding opposite value in a related pair; (5) if a match is not determined, scanning segments of the data in each of the cells; (6) identifying a category of data for obfuscation for each segment; (7) applying an obfuscation rule for each category identified for obfuscating the data segment; and (8) replacing the data segment in each cell with an obfuscated segment based upon the rule associated with the identified category.

In accordance with an embodiment of the present disclosure, a system is disclosed for providing a data obfuscation platform useful for improved data security of preprocessing analysis by a third party server, the data to be analyzed being tabular data created by a plurality of applications and stored in different formats and/or organized by different standards recognizing tabular data created by a plurality of applications and stored in different formats and/or organized by different standards, the system comprising: (a) a data store for storing (1) sets of unrecognizable tabular data created by a plurality of applications of different formats and/or organized by different standards, each set of tabular data having cells of data within one or more input columns and (2) a plurality of categories for the data within the cells and a plurality of rules for obfuscating the data within the cells based on the categories; and (b) one or more servers coupled to the data store and programmed to: (1) identifying the column names of the input columns; (2) for data in each cell of the one or more input columns, trimming leading and trailing white space; (3) determining whether a data in each cell matches a value of designated set of pair of Boolean values where each pair corresponds to a distinctly formatted se of true and false values; (4) if a match is determined, randomly selecting to retain current value or corresponding opposite value in a related pair; (5) if a match is not determined, scanning segments of the data in each of the cells; (6) identifying a category of data for obfuscation for each segment; (7) applying an obfuscation rule for each category identified for obfuscation on the data segment; and (8) replacing the data segment in each cell with an obfuscated segment based upon the rule associated with the identified category.

In accordance with an embodiment of the present disclosure, a system is disclosed for providing a data obfuscation platform useful for improved data security of preprocessing analysis by a third party server, the data to be analyzed created by a plurality of applications and stored in different formats and/or organized by different standards recognizing data created by a plurality of applications and stored in different formats and/or organized by different standards, the system comprising: (a) a data store for storing (1) sets of preprocessing analysis data created from a plurality of applications of different formats and/or organized by different standards, each set of data having cells of data within one or more input columns and (2) a plurality of categories for the data within the cells and a plurality of rules for obfuscating the data within the cells based on the categories; and (b) one or more servers coupled to the data store and programmed to: (1) for data in each cell, trimming leading and trailing white space; (2) determining whether a data in each cell matches a value of designated set of pair of Boolean values where each pair corresponds to a distinctly formatted se of true and false values; (4) if a match is determined, randomly selecting to retain current value or corresponding opposite value in a related pair; (5) if a match is not determined, scanning segments of the data in each of the cells; (6) identifying a category of data for obfuscation for each segment; (7) applying an obfuscation rule for each category identified for obfuscation on the data segment; and (8) replacing the data segment in each cell with an obfuscated segment based upon the rule associated with the identified category.

In accordance with another embodiment of the disclosure, a system is provided for providing a data obfuscation platform useful for improved data security of preprocessing analysis of data by a third party server, the data to be analyzed being tabular data created by a plurality of applications and stored in different formats and/or organized by different standards, the system comprising: (a) a data store for storing: (1) sets of pre-processing analysis tabular data created by a plurality of applications of different formats and/or organized by different standards, each set of tabular data having cells of data within one or more input columns; (2) a plurality of categories for the pre-processing analysis tabular data within the cells and a plurality of rules for obfuscating the pre-processing analysis tabular data within the cells based on the categories; and (3) a data obfuscation engine for obfuscating the pre-processing analysis tabular data within the cells; (4) a data transformation engine for transforming the pre-processing analysis tabular data within the cells based on application instructions created by a data recognition engine on the data obfuscated by the obfuscation engine; (b) one or more servers coupled to the data store and programmed to: (1) obfuscate the data within the cells by the data obfuscation engine before data preprocessing analysis by the third party server; (2) applying the instructions, using the data transformation engine, to transform the pre-processing analysis tabular data within the cells after data preprocessing analysis by the third party server.

In accordance with another embodiment of the present disclosure, a computer implemented method the transformation of data in such a manner as to obfuscate content of the data for the purpose of data privacy and sensitivity, without losing other properties of the data for preprocessing the data including standardization and/or normalization of the data, the data comprising data within cells of one or more input columns, the method comprising executing on one or more processors the steps of: (a) identifying the column names of the input columns; (b)for data in each cell of the one or more columns, trimming leading and trailing white space; (c) determining whether a data in each cell matches a value of designated set of pair of Boolean values where each pair corresponds to a distinctly formatted set of true and false values; (d) if a match is determined, randomly selecting to retain current value or corresponding opposite value in a related pair; (e) if a match is not determined, scanning segments of the data in each of the cells; (f) identifying a category of data for obfuscation for each segment; (g) applying an obfuscation rule for each category identified for obfuscating the data segment; and (e) replacing the data segment in each cell with an obfuscated segment based upon the rule associated with the identified category.

In accordance with another embodiment of the disclosure, a system is disclosed for providing a data obfuscation platform useful for improved data security of preprocessing analysis of the data by a third party server, the system comprising: (a)a data store for storing: (1) sets of pre-processing analysis data created by a plurality of applications of different formats and/or organized by different standards; (2) a plurality of categories for the pre-processing the data and a plurality of rules for obfuscating the pre-processing data based on the categories; and (3) a data obfuscation engine for obfuscating the pre-processing analysis data; (b) one or more servers coupled to the data store and programmed to obfuscate the data by the data obfuscation engine before data preprocessing analysis by the third party server.

### BRIEF DESCRIPTION OF DRAWINGS

FIG. 1 depicts a block diagram illustrating an example system in which a data obfuscation platform for improved data security of preprocessing analysis by third parties operates.

FIG. 2 depicts a block diagram of the data obfuscation platform functioning with components used for recognizing data.

FIG. 3 depicts example method steps for implementing the data obfuscation platform 200 disclosed herein.

FIG. 4 depicts an example table with several columns and rows of obfuscated data.

FIG. 5 depicts the example table in FIG. 4 with several columns and rows of data obfuscated by obfuscation engine described herein).

### DETAILED DESCRIPTION OF THE INVENTION

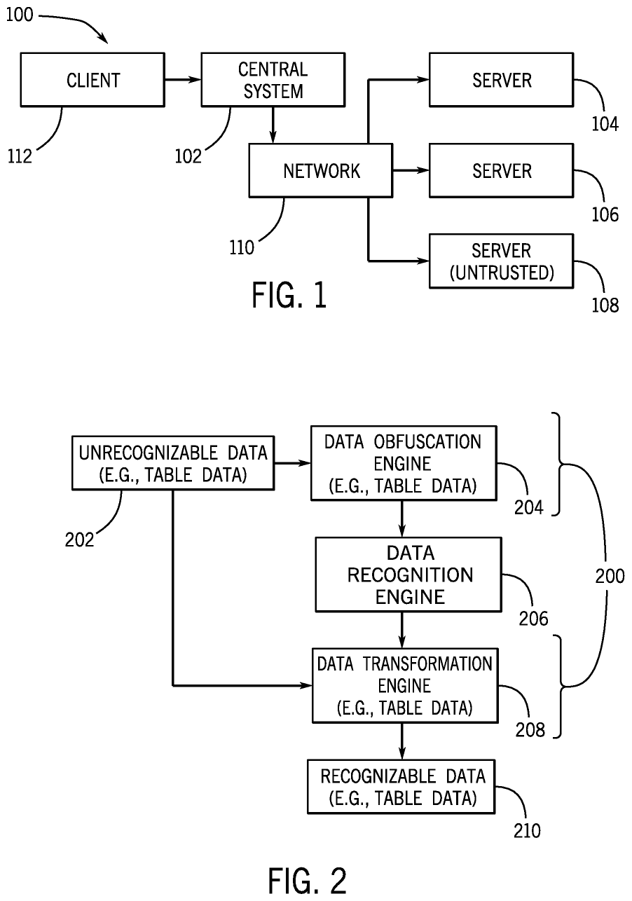

FIG. 1 depicts a block diagram illustrating an example system 100 in which data obfuscation platform 200 (described below) for improved data security of preprocessing analysis by third parties (or sources) operates. The third parties may be “untrusted” or “trusted sources”. Preprocessing occurs before data recognition, as an example, by third parties (or sources). In this embodiment, system 100 incorporates central system 102 that is connected to several servers 104, 106, 108, via network 110 or directly as known to those skilled in the art. Network 110 may be the Internet, a local area network (LAN) and/or any other network as known to those skilled in the art. Client 112 may communicate with central system 102 over network 110 by cable, ISDN, WIFI or wireless carrier networks as known to those skilled in the art. (Data and information are used interchangeably in this disclosure unless otherwise noted.). It is noted that server 108 is designated as a third party. That is, server 108 is owned and managed by a third party. Server 108 thus is designated as a third party server in FIG. 1.

Each example client 112 includes a personal computer and a monitor. However, client 112 may be smartphones, cellular telephones, tablets, PDAs, or other devices equipped with industry standard (e.g., HTML, HTTP etc.) browsers or any other application having wired (e.g., Ethernet) or wireless access (e.g., cellular, Bluetooth, IEEE 802.11b etc.) via networking (e.g., TCP/IP) to nearby and/or remote computers, peripherals, and appliances, etc. TCP/IP (transfer control protocol/Internet protocol) is the most common means of communication today between clients or between clients and central system 102 or other systems (i.e., one or more servers), each client having an internal TCP/IP/hardware protocol stack, where the “hardware” portion of the protocol stack could be Ethernet, Token Ring, Bluetooth, IEEE 802.11b, or whatever software protocol is needed to facilitate the transfer of IP packets over a local area network.

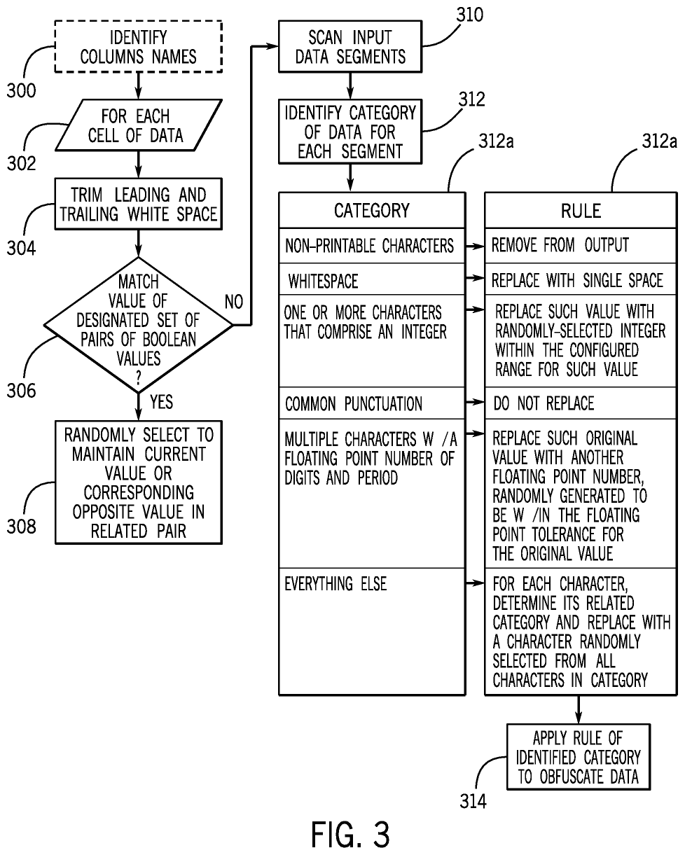

FIG. 2 depicts a block diagram of the data obfuscation platform 200 functioning along with components used for performing preprocessing analysis of the data. In this example, preprocessing occurs before data recognition. In FIG. 2, platform 200 is used in a data recognition system. Platform 200 operates within central system 102 in FIG. 1, but those skilled in the art know that components or modules of platform 200 may operate in any number of systems. Platform 200 comprises data obfuscation engine 204 and data transformation engine 208. In this embodiment, data recognition engine 206 operated or functions within third party server 108. (Data obfuscation is also referred to as data masking.) Table data is an example of the type of data to be recognized but other types of data may be used as known those skilled in the art. In operation, unrecognizable data is processed by the data obfuscation engine 204. In this way, the original data will remain meaningful on several levels. That is, data obfuscation engine 204 performs format-preserving obfuscation wherein the data is masked but the structure is recognizable (i.e., maintained.) Specifically, in more detail, the data will (1) remain understandable for application logic and subsequent functionality, (2) undergo sufficient changes to that it is not obvious that the obfuscated data identifies the source of the production data, (3) be consistent across multiple databases within an organization when the databases each contain the specific data element being obfuscated or masked. Thus, obfuscation platform 200, in this example, is thus configured to provide a way to securely use a third party server to perform data recognition (i.e., data mapping on the data without disclosing the original data input). The obfuscated data is no longer sensitive but recognizable for proper mapping. That is, the obfuscation platform 200 performs format-preserving obfuscation wherein the data is masked but the structure is recognizable (i.e., maintained.) Obfuscation platform 200 analyzes data in each cell and assigned a category to that data. Each category has a different obfuscation process or rule to be applied to the data based on category identified. In this respect, the original data is randomly obfuscated based on the rules as configured. In brief, obfuscation rules may include (1) Boolean obfuscation wherein data type and format are retained (e.g., look entire data string and determine if it data string has a Boolean match, randomly retain it or not), (2) randomized obfuscation wherein a percentage of the original data may be randomized by percentage, (3) text obfuscation wherein characters are substituted, one by one, within the same class (e.g., if a space, leave it as a space, if a lower-case letter, substitute another lower-case letter) and/or (4) stable obfuscation wherein for any input value that appears more than once, the corresponding obfuscated value is always the same (for example, if “abc” appears twice, then a volatile approach would generate and output a new obfuscated value each time, resulting in two different output values such as “der” and “xyz,” whereas a stable approach would obfuscate it once the first time it was encountered, and output that same obfuscated value each subsequent time “abc” was encountered, resulting in a single obfuscated value such as “der” and “xyz”). Obfuscation platform 200 is described in more detail below with respect to the method steps in FIG. 3.

Now, data recognition engine 206 acts upon the obfuscated data for data recognition. Data recognition engine 206 may be part of any number of data recognition systems. Example data recognition systems include the data recognition system disclosed in U.S. Pat. No. 10,740,314 to Wong which is incorporated by reference herein, as well as data mapping systems offered by Salesforce. Following this data recognition, data transformation engine 208 then is applied to the original data set from 202 to return the data so that the original data is now completely recognizable 210. Operation of this appears below with an example.

As an example, (1) a data set in CSV (comma separated values) format may appear as follows:
First, Last, Birth
Jon, Smiths, Dec. 1, 2005

(2) Data obfuscation engine 204 may then change the data as follows:
First, Last, Birth
Vne, Olqhcj, Jun. 8, 2007

(3) Data recognition engine may use the input, together with a predefined data domain which contains normalized column names “First Name”, “Last Name” and “Date of Birth” and return transformation instructions or formulas for transformation engine 208 to use as follows:
First Name:
   map to “First”
Last Name:
   map to “Last”
Date of Birth:
   map to “Birth”
   transform to standard date format using the formula: format ([Date of Birth], “yyy-mm-dd”)

(4) Then, return to “recognized” or “recognizable” data. Transformation engine 208 would apply the instructions or formulas above to the original data set (in (1) above) to obtain the following:
First Name, Last Name, Date of Birth
Jon, Smiths, 2005 Dec. 1

In the example above, transformation engine 208 is used to apply instructions or formulas created by data recognition engine 206 to the original (pre-preprocessing) data set. However, the existence of a transformation engine may or may not be in possession of the party that possesses the original data set as known to those skilled in the art. The transformation engine may be in the possession of and employed by another party.

FIG. 3 depicts example method steps for implementing the data obfuscation platform 200 disclosed herein. Execution begins at step 300 wherein the column names are identified in an example table. Column names are not obfuscated as they are usually not sensitive data. (Step 300 is shown in dashed lines as it applies to tabular data sets where columns and rows are incorporated structurally. However, as described herein, the method steps may apply to any type of data set of any structure.) Next, execution proceeds to steps 302-304 wherein for each cell of data, leading and trailing white space is trimmed. Now, the data is checked at decision step 306. If the data matches any value within a designated set of pairs of Boolean values, where each pair corresponds to a distinctly formatted set of true and false values, then obfuscation engine randomly chooses whether to keep the current value or to use the corresponding opposite value in the related pair and return the appropriate value. The designated set of pairs is configurable and it may contain localized values such in any character script. For example, common Boolean pairs might include “TRUE” and “FALSE”, “Y” and “N” or “Yes” and “No”, while a corresponding non-ascii pair in Chinese might be “ [symbol] ” and “ [symbol] ”. Further, in the process of obfuscation, the probability used to determine whether to keep the same value or to use the other value in the pair configurable and may be dynamic. If no match is made, however, at decision diamond step 306, then execution proceeds to step 310.

In step 310, input data segments are each scanned per cell. Then, where each segment consisting of the longest contiguous string of characters belonging to the same category (as define below) is identified at step 312, the string of one or more characters in that segment are replaced with a new string of characters based on the obfuscation rules associated with the categories described below. In other words, category identification in step 312 is applied to each segment (in a looping fashion as known to those skilled in the art) until all segments are identified.

Categories and associated obfuscation rules (columns 312a and 312b in FIG. 3) are shown below.

(1) Non-printable characters—remove the data characters from the output (and replace with an empty string).

(2) Whitespace—replace the data with a single space.

(3) Common punctuation (e.g., a dash, period, slash or colon)—do not replace any data. This specific list of punctuation in this category is configurable and may be localized (e.g., it may include a long dash and a medium dash).

(4) Multiple characters with a floating-point number of digits and period (e.g., 123.45)—replace such original value with another floating-point number, randomly generate to be within a “floating point number tolerance” of the original value, rounded to the same number of decimal places as the original value and generated such that the number of digits to the left of the decimal point is the same as it is for the original value. This may include formatted floating-point or date strings, such as commas or scientific notation (e.g., “1,224.56” or “1.234E-03”), or date formats (e.g., “Dec. 1, 2020”) in which case the randomly generated replacement should retain the same formatting style when output. This obfuscation category rule may be configurable, but the generated random value should not contain leading or trailing zeros unless the original contained leading or trailing zeros, respectively. The “floating-point number obfuscation range” for any given original value is a range with a lower bound of a value, calculated via a configurable formula, and an upper bound of a value, calculated by a configurable formula (e.g., it could be the original value ±10%). The calculation may be a specified amount or may be determined as a function of such original value (e.g., for numbers between 13-125, ±20% as the percentage of original value; for numbers between 126-1000, ±10% as percentage of the original value) or determined as a function of the entire dataset (e.g., 10% above or below the highest or lowest value in that column).

(5) One or more characters that comprise an integer—replace the value with a randomly selected integer within the configured range for such value. For example, the range might be 0-9 for values of “0”, 1-9 for any value>0 and <10, −1 through −0 for any value<0 and >-10, and ±10% of any other value.

(6) Everything else that does not fall within the categories above—for each character, determine its related “character bucket” (also called a category as described herein) and replace it with a character that is randomly selected from all characters in such bucket. A character bucket is configurable and consists of one or more characters. The sum of all character buckets should be designed to cover all characteristics that could be contained in the input. For example, for ascii only input, there may be three character buckets such as (1) upper letters (A-Z), (2) lower letters (a-z) and (3) everything else. For Unicode input, there might be a separate character bucket for each unique combination of block, category, script, case and/or numeric type, as defined by the Unicode standard or any other customized bucketing approach.

Once a category has been identified (selected), execution proceeds to step 314 wherein the applicable rule is applied for that category identified. Then, execution proceeds to determine if there are additional cells with data (not shown). If so, execution returns to step 302. If not execution ends. (Also not shown in FIG. 3).

In the current obfuscation platform described above, data may be blacked out or randomized as described but the data structure remains intact. That is, data obfuscating does not lose any data structure and obfuscated data may be used as needed. The resulting obfuscated data, that is used as needed, will provide useful information to be subsequently used when viewing or using the original data set (as copied).

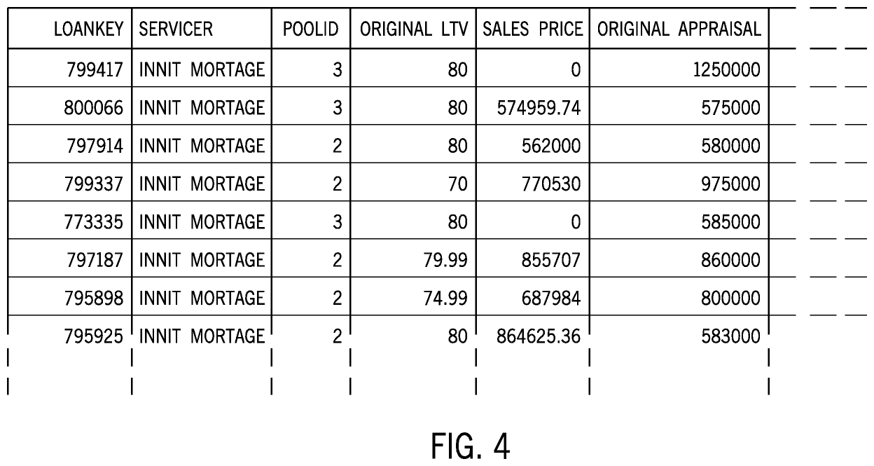

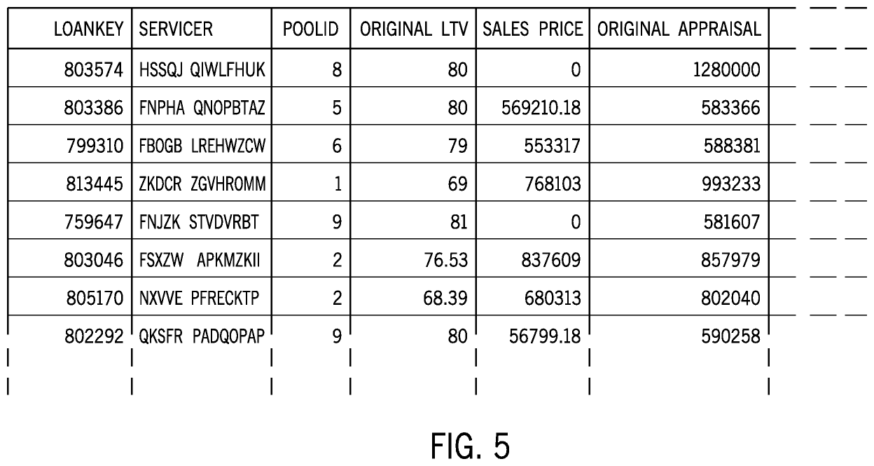

FIG. 4 depicts an example table with several columns and rows of unobfuscated data. Specifically, the columns depict columns including “Loankey,” “Servicer,” “PoolID,” “Original Ltv,” “Sales Price,” and “Original Appraisal.” The data under the columns is presented in its original unobstructed form. FIG. 5 depicts the example table in FIG. 4 with several columns and rows of data obfuscated by obfuscation engine described herein). In column entitled “Loankey,” the data value 799417 has been converted or obfuscated to 803574 by randomly generating a number within the calculated obfuscation range of the original value and with the same number of digits past the decimal (in this case, zero since it is an integer). Under the category of one or more characters together comprise and integer, each data value has been replaced randomly selected by range or percentage. Under the Servicer column, “Innit Mortgage” has been changed to “Hssqj Qiwlfhuj” by replacing each on-white character with a randomly-generated character within the same “bucket,” where the bucket in the case of “H” and “Q” is “upper-case ASCII letters” and in the case of the other letters is “lower-case ASCII letters.”

It is to be understood that the disclosure teaches examples of the illustrative embodiments and that many variations of the invention can easily be devised by those skilled in the art after reading this disclosure and that the scope of the present invention is to be determined by the claims below.

What is claimed is:

1. A computer implemented method for providing a data obfuscation platform for improved data security of preprocessing analysis by a third party server, the data to be analyzed being tabular data created by a plurality of applications and stored in different formats and/or organized by different standards, the tabular data comprising data within cells of one or more input columns, the method comprising executing on one or more processors the steps of:
(a) identifying the column names of the input columns;
(b) for data in each cell of the one or more columns, trimming leading and trailing white space;
(c) determining whether a data in each cell matches a value of designated set of pair of Boolean values where each pair corresponds to a distinctly formatted set of true and false values;
(d) if a match is determined, randomly selecting to retain current value or corresponding opposite value in a related pair;
(e) if a match is not determined, scanning segments of the data in each of the cells;
(f) identifying a category of data for obfuscation for each segment;
(g) applying an obfuscation rule for each category identified for obfuscating the data segment; and
(e) replacing the data segment in each cell with an obfuscated segment based upon the rule associated with the identified category.

2. The computer implemented method of claim 1 wherein for non-printable data characters identified for a first category, remove the data characters and replace with an empty string of data characters based upon the rule associated with the identified category.

3. The computer implemented method of claim 1 wherein for whitespace identified for a second category, replace the data with a single space based upon the rule associated with the identified category.

4. The computer implemented method of claim 1 wherein for multiple characters with a floating point number of digits and period, replace an original value with another floating point number, randomly generated to be within the floating point tolerance for the original based upon the rule associated with the identified category.

5. The computer implemented method of claim 1 wherein for multiple characters with a floating-point number of digits and period, replace an original value with another floating point number, randomly generated to be within the floating point tolerance for the original based upon the rule associated with the identified category.

6. The computer implemented method of claim 1 wherein for common data punctuation, multiple characters with a floating-point number of digits and period, replace no data based upon the rule associated with the identified category.

7. The computer implemented method of claim 1 wherein for one or more characters that comprise and integer, replace value with randomly-selected integer within the configured range for such value based upon the rule associated with the identified category.

8. The computer implemented method of claim 1 wherein for one or more characters that comprise and integer, replace value with randomly-selected integer within the configured range for such value based upon the rule associated with the identified category.

9. The computer implemented method of claim 1 wherein for data not identified by category and for each character, determine its related category and replace data with a character randomly selected from all characters in that related category.

10. A system for providing a data obfuscation platform useful for improved tabular data security of preprocessing analysis by a third party server, the data to be analyzed being tabular data created by a plurality of applications and stored in different formats and/or organized by different standards, the system comprising:
(a) a data store for storing (1) sets of unrecogizable tabular data created by a plurality of applications of different formats and/or organized by different standards, each set of tabular data having cells of data within one or more input columns and (2) a plurality of categories for the data within the cells and a plurality of rules for obfuscating the data within the cells based on the categories; and
(b) one or more servers coupled to the data store and programmed to:
(1) identifying the column names of the input columns;
(2) for data in each cell of the one or more input columns, trimming leading and trailing white space;
(3) determining whether a data in each cell matches a value of designated set of pair of Boolean values where each pair corresponds to a distinctly formatted se of true and false values;
(4) if a match is determined, randomly selecting to retain current value or corresponding opposite value in a related pair;
(5) if a match is not determined, scanning segments of the data in each of the cells;
(6) identifying a category of data for obfuscation for each segment;
(7) applying an obfuscation rule for each category identified for obfuscation on the data segment; and
(8) replacing the data segment in each cell with an obfuscated segment based upon the rule associated with the identified category.

11. The system of claim 10 wherein the one or more servers are further programmed to, for non-printable data characters identified for a first category, remove the data characters and replace with an empty string of data characters based upon the rule associated with the identified category.

12. The system of claim 10 wherein the one or more servers are further programmed to, for whitespace identified for a second category, replace the data with a single space based upon the rule associated with the identified category.

13. The system of claim 10 wherein the one or more servers are further programmed to, for multiple characters with a floating pint number of digits and period, replace an original value with another floating point number, randomly generated to be within the floating point tolerance for the original based upon the rule associated with the identified category.

14. The system of claim 10 wherein the one or more servers are further programmed to, for multiple characters with a floating-point number of digits and period, replace an original value with another floating point number, randomly generated to be within the floating point tolerance for the original based upon the rule associated with the identified category.

15. The system of claim 10 wherein the one or more servers are further programmed to, for common data punctuation, multiple characters with a floating-point number of digits and period, replace no data based upon the rule associated with the identified category.

16. The system of claim 10 wherein the one or more servers are further programmed to, for one or more characters that comprise and integer, replace value with randomly-selected integer within the configured range for such value based upon the rule associated with the identified category.

17. The system of claim 10 wherein the one or more servers are further programmed to, for one or more characters that comprise and integer, replace value with randomly-selected integer within the configured range for such value based upon the rule associated with the identified category.

18. The system of claim 10 wherein the one or more servers are further programmed to, for data not identified by category and for each character, determine its related category and replace data with a character randomly selected from all characters in that related category.

19. A system for providing a data obfuscation platform useful for improved data security of preprocessing analysis by a third party server, the data to be analyzed being tabular data created by a plurality of applications and stored in different formats and/or organized by different standards, the system comprising:
(a) a data store for storing (1) sets of pre-analysis data created from a plurality of applications of different formats and/or organized by different standards, each set of data having cells of data within one or more input columns and (2) a plurality of categories for the data within the cells and a plurality of rules for obfuscating the data within the cells based on the categories; and
(b) one or more servers coupled to the data store and programmed to:
(1) for data in each cell, trimming leading and trailing white space;
(2) determining whether a data in each cell matches a value of designated set of pair of Boolean values where each pair corresponds to a distinctly formatted se of true and false values;
(4) if a match is determined, randomly selecting to retain current value or corresponding opposite value in a related pair;
(5) if a match is not determined, scanning segments of the data in each of the cells;
(6) identifying a category of data for obfuscation for each segment;
(7) applying an obfuscation rule for each category identified for obfuscation on the data segment; and
(8) replacing the data segment in each cell with an obfuscated segment based upon the rule associated with the identified category.

20. A system for providing a data obfuscation platform useful for improved data security of preprocessing analysis of data by a third party server, the data to be analyzed being tabular data created by a plurality of applications and stored in different formats and/or organized by different standards, the system comprising:
(a) a data store for storing:
(1) sets of pre-processing analysis tabular data created by a plurality of applications of different formats and/or organized by different standards, each set of tabular data having cells of data within one or more input columns;
(2) a plurality of categories for the pre-processing analysis tabular data within the cells and a plurality of rules for obfuscating the pre-processing analysis tabular data within the cells based on the categories; and
(3) a data obfuscation engine for obfuscating the pre-processing analysis tabular data within the cells;
(4) a data transformation engine for transforming the pre-processing analysis tabular data within the cells based on application instructions created by a data recognition engine on the data obfuscated by the obfuscation engine;
(b) one or more servers coupled to the data store and programmed to:
(1) obfuscate the data within the cells by the data obfuscation engine before data preprocessing analysis by the third party server;
(2) applying the instructions, using the data transformation engine, to transform the pre-processing analysis tabular data within the cells after data preprocessing analysis by the third party server.

21. A computer implemented method the transformation of data in such a manner as to obfuscate content of the data for the purpose of data privacy and sensitivity, without losing other properties of the data for preprocessing the data including standardization and/or normalization of the data, the data comprising data within cells of one or more input columns, the method comprising executing on one or more processors the steps of:
(a) identifying the column names of the input columns;
(b) for data in each cell of the one or more columns, trimming leading and trailing white space;
(c) determining whether a data in each cell matches a value of designated set of pair of Boolean values where each pair corresponds to a distinctly formatted set of true and false values;
(d) if a match is determined, randomly selecting to retain current value or corresponding opposite value in a related pair;
(e) if a match is not determined, scanning segments of the data in each of the cells;
(f) identifying a category of data for obfuscation for each segment;
(g) applying an obfuscation rule for each category identified for obfuscating the data segment; and
(e) replacing the data segment in each cell with an obfuscated segment based upon the rule associated with the identified category.

22. A system for providing a data obfuscation platform useful for improved data security of preprocessing analysis of the data by a third party server, the system comprising:
(a) a data store for storing:
(1) sets of pre-processing analysis data created by a plurality of applications of different formats and/or organized by different standards;
(2) a plurality of categories for the pre-processing the data and a plurality of rules for obfuscating the pre-processing data based on the categories; and
(3) a data obfuscation engine for obfuscating the pre-processing analysis data;
(b) one or more servers coupled to the data store and programmed to obfuscate the data by the data obfuscation engine before data preprocessing analysis by the third party server.

23. The system of claim 22 wherein the data store stores a data recognition engine for performing data recognition on data obfuscated by the obfuscation engine.

24. The system of claim 23 wherein the one or more servers further programmed to perform data recognition on the obfuscated data and generate instructions for transforming the pre-processing data.

25. The system of claim 24 wherein the one or more servers further programmed to apply the instructions to the pre-processing data, by the transformation engine, to transform the pre-processing data.
